(19) United States
(12) Patent Application Publication
(10) Pub. No.: US 2014/0321110 A1
(43) Pub. Date: Oct. 30, 2014

(54) LIGHT TUBE DEVICE

(71) Applicant: Lextar Electronics Corporation, Hsinchu (TW)

(72) Inventors: Kuo-Ching CHEN, Miaoli County (TW); Chih-Peng CHANG, Taichung City (TW)

(73) Assignee: Lextar Electronics Corporation, Hsinchu (TW)

(21) Appl. No.: 14/048,056

(22) Filed: Oct. 8, 2013

(30) Foreign Application Priority Data
Apr. 29, 2013 (TW) 102115255

(51) Int. Cl. F21V 29/00; F21K 99/00

(52) U.S. Cl. CPC F21V 29/22; F21K 9/175
USPC 362/218

(57) ABSTRACT

A light tube device includes a light bar section and a heat dissipation structure. The light bar section and a heat dissipation structure is a single-piece integrally formed structure, and collectively form a hollow tube. An insulating layer, a copper foil layer and a solder mask layer are sequentially formed on the light bar section, and the solder mask layer is patterned to expose the copper foil layer so as to serve as welding zones. A plurality of light emitting units are located on the welding zones respectively and electrically connected to the copper foil layer to form a light bar.

### RELATED APPLICATIONS

This application claims priority to Taiwan Application. Serial Number 102115255, filed Apr. 29, 2013, which is herein incorporated by reference.

### BACKGROUND

1. Field of Invention

The present invention relates to an LED light tube device

2. Description of Related Art

Light-emitting diode (LED) is a semiconductor light-emitting element. Due to the advantages, e.g., the power consumption, high luminous efficiency, long life and environmental protection which cannot be achieved by the traditional light sources, as well as the different colors of light-emitting diodes, such as blue, ultraviolet, red or white, one by one to be developed, such that the light emitting diode becomes one of the important light emitting devices today.

The current LED light tubes mostly contain an LED light bar and a heat dissipation structure, which are manufactured separately and assembled or fastened by using a thermal grease or a thermal adhesive. When the LED light bar operates, the heat generated by LEDs is transferred to the heat dissipation structure via the thermal adhesive or thermal grease. Even if the thermal adhesive or thermal grease is equipped with not bad thermal performance, the high power LED light bar still has problems to effectively transfer the heat to the heat dissipation structure.

### SUMMARY

It is therefore an objective of the present invention to provide an improved light tube device to deal with a heat dissipation issue.

In accordance with the foregoing and other objectives of the present invention, a light tube device includes a light bar section and a heat dissipation structure. The light bar section and a heat dissipation structure is a single-piece integrally formed structure, and collectively form a hollow tube. An insulating layer, a copper foil layer and a solder mask layer are sequentially formed on the light bar section, and the solder mask layer is patterned to expose the copper foil liner so as to serve as welding zones. A plurality of light emitting units are located on the welding zones respectively and electrically connected to the copper foil layer to form a light bar.

According to another embodiment disclosed herein, the light bar section and the heat dissipation structure is a one-piece bending or extruding metal plate.

According to another embodiment disclosed herein, the metal plate is an aluminum plate.

According to another embodiment disclosed herein, the light emitting units are light emitting diodes.

According to another embodiment disclosed herein, the light tube device further includes a transparent lampshade attached to two opposite edges of the heat dissipation structure to collectively form a complete tube.

According to another embodiment disclosed herein, two opposite edges of the heat dissipation structure, which are adjacent to two opposite edges of the light bar section, each comprises a rail slot which the transparent lampshade engages.

According to another embodiment disclosed herein, the metal plate has a thickness ranging from 1 mm to 2 mm.

According to another embodiment disclosed herein, the insulating layer has a thickness ranging from 50 μm in to 150 μm.

According to another embodiment disclosed herein, the copper foil layer has a thickness ranging from 25 μm to 80 μm.

Thus, the present invention provides a light tube device, which is made from a single-piece integrally formed structure of a light bar metal substrate and a heat dissipation structure. An insulating layer, a copper foil layer and a solder mask layer are sequentially formed on the light bar section of the metal plate (i.e., the light bar metal substrate), and the metal plate except the light bar section is bent to form the heat dissipation structure such that the beat generated by the LED light bar can be transferred to the heat dissipation structure effectively and via less thermal barriers.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a side view of a light tube device according to one embodiment of this invention;

FIG. 2 illustrates the light tube device in FIG. 1 with its transparent lampshade removed;

FIG. 3 illustrates a perspective view of the light tube device in FIG. 1; and

FIGS. 4-8 illustrate a series of steps for manufacturing a light tube device according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In order to deal with a heat dissipation issue of a conventional LED light tube, the present invention provides a single-piece integrally formed structure of an LED light bar substrate and a heat dissipation structure such that the heat generated by the LED light bar can be transferred to the heat dissipation structure effectively and via less thermal barriers.

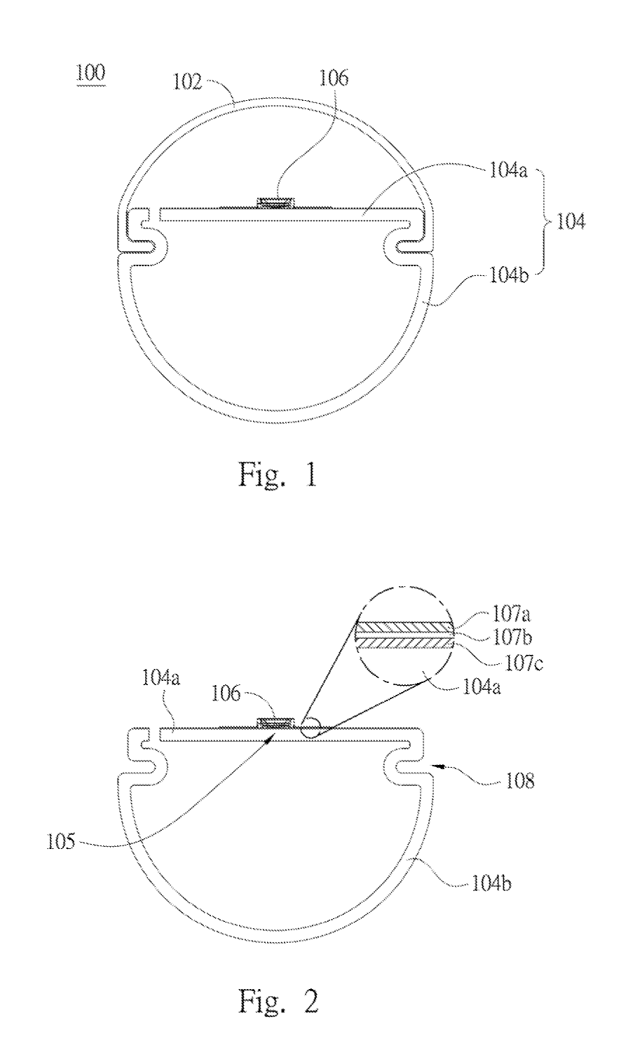

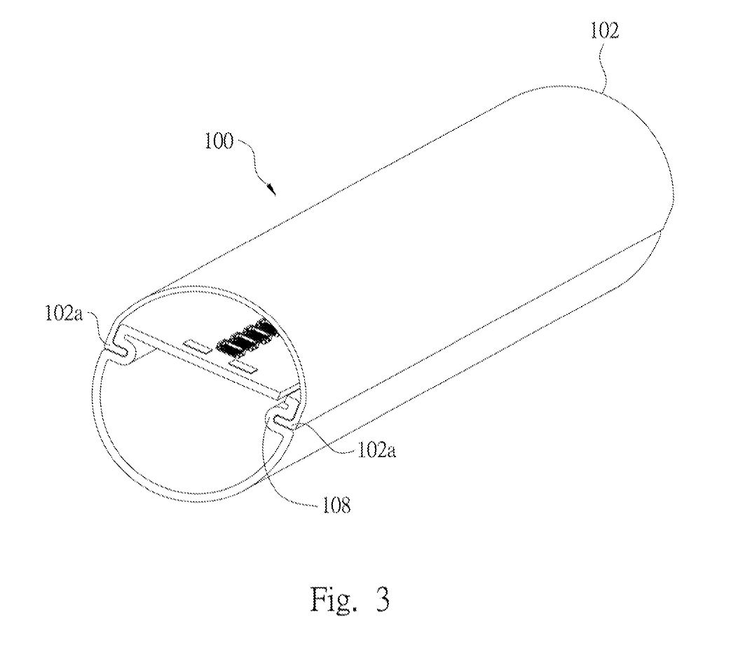

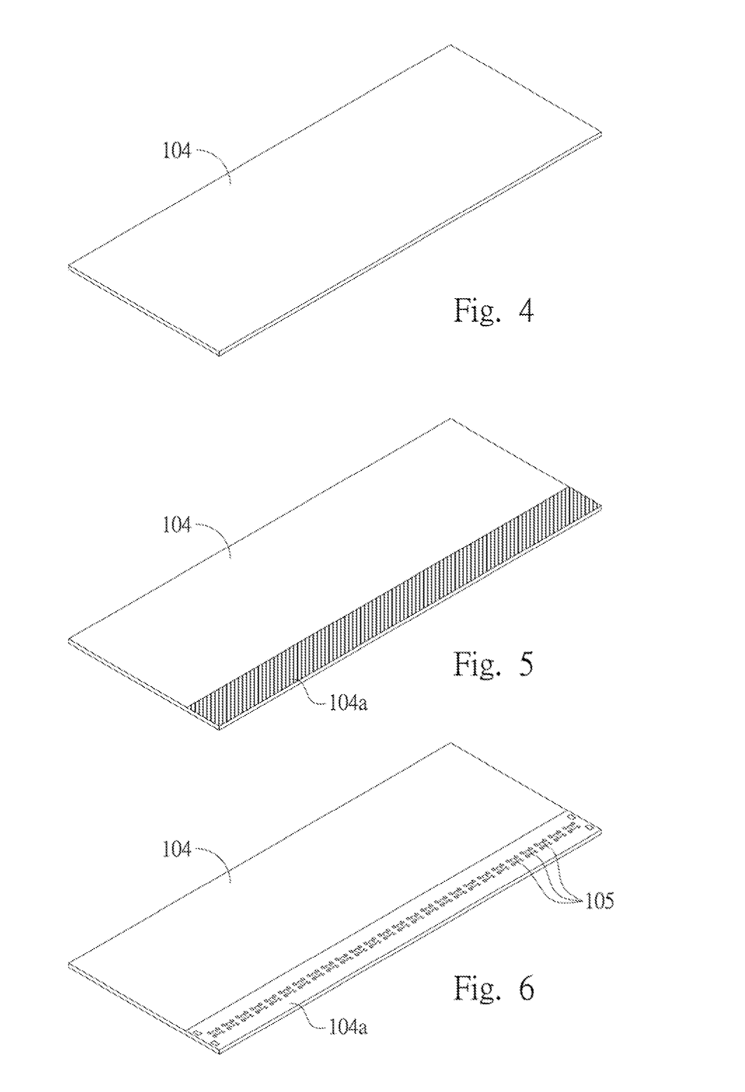

Referring to FIGS. 1-3, FIG. 1 illustrates a side view of a light tube device according to one embodiment of this invention, FIG. 2 illustrates the light tube device in FIG. 1 with its transparent lampshade removed, and FIG. 3 illustrates a perspective view of the light tube device in FIG. 1. A light tube device 100 includes a light bar section 104a and a heat dissipation structure 104b. Compared with a conventional light tube device, the light bar section 104a and heat dissipation structure 104b is to single-piece integrally formed structure. By the term “single-piece integrally formed structure”, it means the light bar section 104a and heat dissipation structure 104b is made from a ductile metallic sheet of high thermal conductivity, which has no seams between the light bar section 104a and heat dissipation structure 104b. In this embodiment, the light bar section 104a and heat dissipation structure 104b can be, but not being limited to, a one-piece bending or extruding metal plate 104. In addition, the metal plate 104 can be, but not limited to, an aluminum plate.

An insulating layer 107c, a copper foil layer 107b and a solder mask layer 107a are sequentially formed on and within the light bar section 104a, and the solder mask layer 107a is patterned to expose the copper foil layer 107b below so as to serve as welding zones. Therefore, when multiple light emitting units 106 are mounted on a welding zone 105, the heat generated by the light emitting units 106 can be transferred to the light bar section 104a and then transferred to the heat dissipation structure 104b efficiently. By reviewing a thermal transferring route from the light emitting units 106 to the light bar section 104a, the insulating layer 107c may be regarded as a “thermal barrier” (it is noted that the welding zone 105 is not covered by the solder mask layer 107a, i.e., another “thermal barrier”). In addition, the light bar section 104a and heat dissipation structure 104b is a single-piece integrally formed structure, the thermal conductivity between the light bar section 104a and the heat dissipation structure 104b is superior to any thermal interface formed by thermal pastes or adhesives added therebetween. Therefore, the light tube device 100 is equipped with a better heat dissipation efficiency than a conventional LED light tube is. In this embodiment, the light emitting units 106 can be light emitting diodes, but the light tube device may include other light emitting semiconductors as its light source.

In this embodiment, the metal plate 104 has a thickness ranging from 1 mm to 2 mm, the insulating, layer 107c has a thickness ranging from 50 μm to 150 μm, and the copper foil layer 107b has a thickness ranging from 25 μm in to 80 μm, but these plate and layers are not limited to the above-mentioned thickness.

In this embodiment, the light bar section 104a and the heat dissipation structure 104b is a one-piece bending or extruding metal plate and collectively form at hollow tube. The heat dissipation structure 104b may be further equipped with designs on inner or outer surfaces to increase the thermal dissipating surface area in order to increase thermal performance.

In this embodiment, the light tube device 100 may further include a transparent lampshade 102, which has two edges 102a attached to two opposite edges of the heat dissipation structure 104b to collectively form a complete tube. Two opposite edges of the heat dissipation structure 104b, which are adjacent to two opposite edges of the light bar section, each includes a rail slot 108 to be engaged by the transparent lampshade 102. The rail slot 108 in the drawing is only an example of the design, and other designs that can be formed by bending or extruding the metal plate 102 are also applicable. In addition, the fasteners at two opposite edges of the transparent lampshade 102 and the fasteners at two opposite edges of the light bar section 104a have complementary-engaging structures, and are not limited to the structures illustrated in FIG. 3.

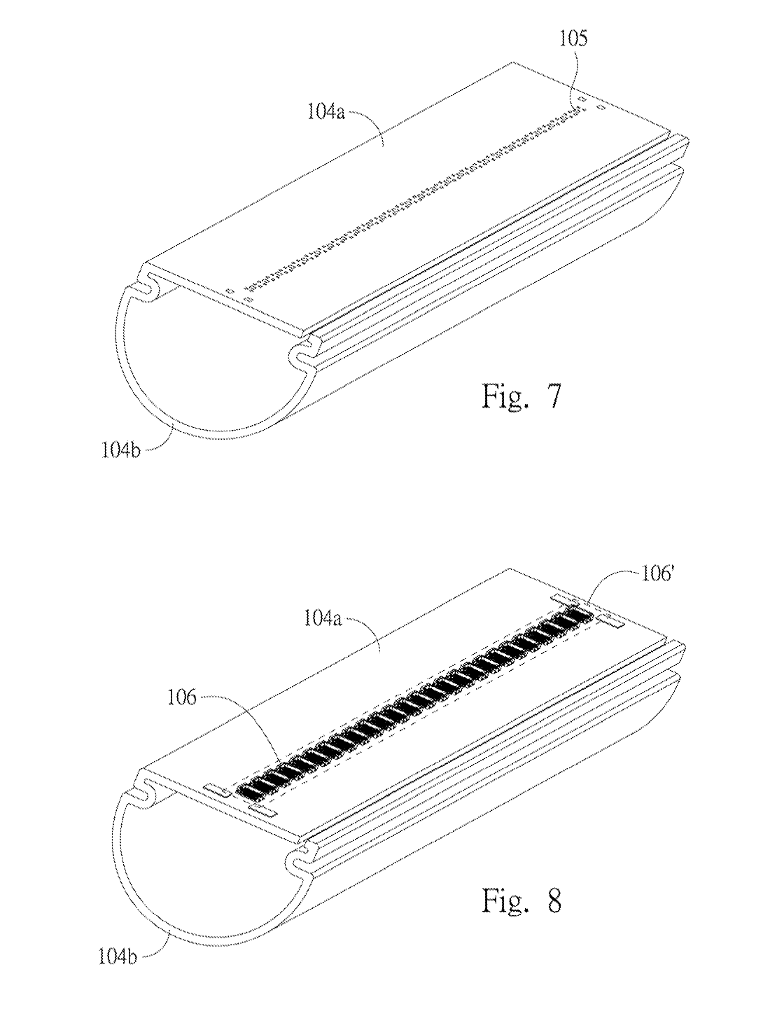

FIGS. 4-8 illustrate a series of steps for manufacturing a light tube device according to one embodiment of this invention.

Referring to FIG. 4, a plate of high thermal conductivity (e.g., a metal plate) is provided to manufacture the light tube device.

Referring to FIG. 5, the light bar section 104a is defined on the metal plate 104, and an insulating layer 107c and copper foil layer 107b are sequentially formed on the light bar section 104a (also referring to FIG. 2).

Referring to FIG. 6, the copper foil layer 107b on the light bar section 104a is patterned to form desired circuits and define welding zones 105. A solder mask layer 107a is covered over the copper foil layer 107b and patterned to define the welding zones 105 (also referring to FIG. 2).

Referring to FIG. 7, the metal plate 104 except the light bar section 104a is bent to form a heat dissipation structure 104b, and the heat dissipation structure 104b and the light bar section 104a collectively form a hollow tube.

Referring to FIG. 8, a plurality of light emitting units 106 are welded on the welding zones 105 respectively, and electrically connected to the copper foil layer to form a light bar 106′. The final step is to add a transparent lampshade 102 to enclose the light bar 106′ so as to collectively form a complete light tube device 100 as illustrated in FIG. 3.

According to the above-discussed embodiments, the present invention provides a light tube device, which is made from a single-piece integrally formed structure of a light bar metal substrate and a heat dissipation structure. An insulating layer, a copper foil layer and a solder mask layer are sequentially formed on the light bar section of the metal plate (i.e., the light bar metal substrate), and the metal plate except the light bar section is bent to form the heat dissipation structure such that the heat generated by the LED light bar can be transferred to the heat dissipation stricture effectively and via less thermal barriers.

It will be apparent to those skilled in the art that various modifications and is variations can be made to the structure of the present invention without departing from the scope or spirit of the invention. In view of the foregoing, it is intended that the present invention cover modifications and variations of this invention provided they fall within the scope of the following claims.

What is claimed is:

1. A light tube device comprising:
a light bar section and a heat dissipation structure being a single-piece integrally formed structure and collectively form a hollow tube;
an insulating layer, a copper foil layer and a solder mask layer sequentially formed on the light bar section, and the solder mask layer is patterned to expose the copper foil layer so as to serve as welding zones; and
a plurality of light emitting units disposed on the welding zones respectively and electrically connected to the copper foil layer to form a light bar.

2. The light tube device of claim 1, wherein the light bar section and the heat dissipation structure is a one-piece bending or extruding metal plate.

3. The light tube device of claim 1, wherein the metal plate is an aluminum plate.

4. The light tube device of claim 1, wherein the light emitting units are light emitting diodes.

5. The light tube device of claim 1, further comprising a transparent lampshade attached to two opposite edges of the heat dissipation structure to collectively form a complete tube.

6. The light tube device of claim 5, wherein two opposite edges of the heat dissipation structure, which are adjacent to two opposite edges of the light bar section, each comprises a rail slot to be engaged by the transparent lampshade.

7. The light tube device of claim 1, wherein the metal plate has a thickness ranging from 1 mm to 2 mm.

8. The light tube device of claim 1, wherein the insulating layer has a thickness ranging from 50 μm in to 150 μm.

9. The light tube device of claim 1, wherein the copper foil layer has a thickness ranging from 25 μm in to 80 μm.
